(19) United States
(12) Patent Application Publication
(10) Pub. No.: US 2009/0254540 A1
(43) Pub. Date: Oct. 8, 2009

(54) METHOD AND APPARATUS FOR AUTOMATED TAG GENERATION FOR DIGITAL CONTENT

(75) Inventors: Timothy A. MUSGROVE, Morgan Hill, CA (US); Robin H. WALSH, San Francisco, CA (US)

Correspondence Address: NIXON PEABODY, LLP, 401 9TH STREET, NW, SUITE 900, WASHINGTON, DC, 20004-2128, US

(73) Assignee: TextDigger, Inc., San Jose, CA (US)

(21) Appl. No.: 12/263,943

(22) Filed: Nov. 3, 2008

Related U.S. Application Data
(60) Provisional application No. 60/984,529, filed on Nov. 1, 2007.
(60) Provisional application No. 61/109,025, filed on Oct. 28, 2008.

(51) Int. Cl. G06F 17/30

(52) U.S. Cl. 707/5; 707/E17.109; 707/100

(57) ABSTRACT

A method and apparatus for automatically generating tags for digital content are provided. The method is adapted to be run on a computer, which is an example of the type of apparatus which may generate the tags. The generated tags describe the digital content, and may be used as topics for the content to organize, retrieve, and process the content. The tag generation begins by accessing content from a content collection unit and a tags candidate tag database unit, which are then processed using techniques from computational linguistics in a multi-pass process that generates sets of tags, then refines and normalizes them. Finally, scores are generated and stored along with the tags.

### CROSS-REFERENCE TO RELATED APPLICATIONS

This application claims priority to provisional U.S. patent application entitled “Automated Tag Generation Specification and Design Notes”, filed Nov. 1, 2007, having Ser. No. 60/984,529, and to provisional U.S. patent application entitled “Topic Tags and Topic Pages Design Notes” filed Oct. 28, 2008, having serial number 61/109,025, the disclosures of which are hereby incorporated by reference in their entirety.

### BACKGROUND OF THE INVENTION

1. Field of the Invention

The invention relates to the tagging of digital content and more specifically to identifying tags that are descriptive of items of digital content based on source documents in a reference collection.

2. Description of the Related Art

As the Internet has grown explosively over the past several years, the sheer volume of content has made it difficult to identify and locate relevant content. Similarly larger content domains, such as enterprise content repositories, have a large volume of content that is difficult to manage. One way of identifying content, and facilitating retrieval of relevant content, is to “tag” the content.

Tags are textual phrases, usually of one or two words, that are capable of being attached to various content items, such as text, video, graphics, or interactive elements on a web page, such as buttons or links. Often tag functionality is built into a system that supports larger files so that subcomponents within that system may be labeled and organized. While tag implementation may vary, one common example of the use of tags is the “rel-tag” format within HTML which indicates that a given hyperlink has an author-specified tag associated with it. Tags describe items, and additionally can facilitate browsing, visualization, or retrieval of the items they describe. This occurs because they act as labels which help to categorize information as well as summarize it.

Tags often exist as “tag clouds”, in that individual users have their own “clouds”, or sets, of tags for association with digital content. Larger set of tags, known as a folksonomy (the merged set of tags for all of the users on a system), can also be used. Tagging was made popular as part of the “Web 2.0” movement and it is a major part of many Web 2.0 services. Web 2.0 refers to newer interactive features that enhance the functionality of the Web, such as blogs, wikis, podcasts and RSS feeds.

Use of the Internet and other document repositories has become increasingly dependent on search engines, which can give special weight to tags that are deemed reliable. Furthermore, tags offer the advantages of site “stickiness” and targeted advertising. Tags allow site stickiness, which means that they enhance the positive attributes of a site and thereby increase the traffic or time in which the users “stick” to the site over a given period of time. Finally, the use of tags can increase the effectiveness of targeted advertising because it can aid advertisers in reaching an audience who might be most likely to represent a good candidate for the advertiser's advertising efforts.

As known and appreciated in the art, there are several qualities of a successful tagging system. First, it should have relevancy to both the item which it tags and to other important content on the site or other domain with which it is associated. Second, it should be normalized, in that a single unified tag can be is associated with different content items with different wording but similar semantic meaning. Third, it should be scalable, so that large amounts of content can be tagged efficiently and with reasonable resources.

However, in order to associate tags with digital content, the tagging process in the past has been done manually. Manual tagging relies upon judgments of users or editors, which may be inconsistent or inaccurate. It is possible to merge the judgments of multiple users together, as noted above, and proceed from the results of a folksonomy. However, the validity of the data is still not assured and regardless of whether one or multiple users are contributing tags manually, it is impossible to guarantee a sufficient supply of tags to accurately label the content if some users choose not to tag certain items. Likewise, certain items may be tagged with disproportionate frequency due to user preferences, even though sufficient information exists to tag others. Also, relevancy may be low due to personal preferences and biases.

It is also known to provide systems for automated tagging of documents. For example, CALAI™, INFORM™, and TERAGRAM™ are all examples of software tools which facilitate automated tagging. Such tools use keyword matching between tags and document content to tag the document. A predefined collection of tags is used and is matched against words in the content to be tagged. These tools attempt to obtain semantic relevance by allowing an editor to define synonyms and to structure the tags in an ontology. In other words, the editor must create a domain specific ontology of tags. However, once the ontology is created, it is static and can only be updated manually.

### SUMMARY OF THE INVENTION

The disclosed embodiments serve the useful purpose of generating tags automatically with a robust ontology. Such tags may have the useful property of functioning as descriptors or topics, for organization or retrieval of the content. For example, such a tag may be used to facilitate retrieval of a page of content tagged by the topic. The embodiments use an external set of tags which can then be associated with the information sources based on the content of the information. The tags can be generated automatically have a valid relationship to the items with which they were associated.

An aspect of the embodiments is a computer implemented method for associating descriptive tags with items of digital content, representing various physical entities, by utilizing computational linguistics techniques to identify tags that are associated with source documents in a reference collections which are descriptive of a plurality of content items. When a tag is associated with an item of digital content, it transforms the content data by affecting the correspondence between the content and what it represents, and by affecting the physical representation of the content on the medium on which the content is stored.

Another aspect comprises accessing a plurality of content items, accessing a collection of descriptive tags, the tags being associated with source documents in a reference collection, utilizing computational linguistics techniques to identity at least one tag in the collection that is descriptive of one of the content items, scoring the at least one tag based on the context of the source document associated with the at least one tag in the collection, and storing each of the at least one tags with a score for the content item. Other exemplary embodiments include an apparatus designed to carry out this method, computer-readable instructions encoded on a computer-readable medium which when executed by a computer carry out this method, and a system which includes means for carrying out this method.

### BRIEF DESCRIPTION OF THE DRAWINGS

The invention is described through embodiments and the attached drawings in which:

FIG. 1 is a block diagram of a computer architecture in accordance with an embodiment.

FIG. 2 is a flowchart of the method of operation of the apparatus of FIG. 1.

FIG. 3 is a flowchart of how step 204, the association step, is carried out.

### DETAILED DESCRIPTION OF THE PREFERRED EMBODIMENT

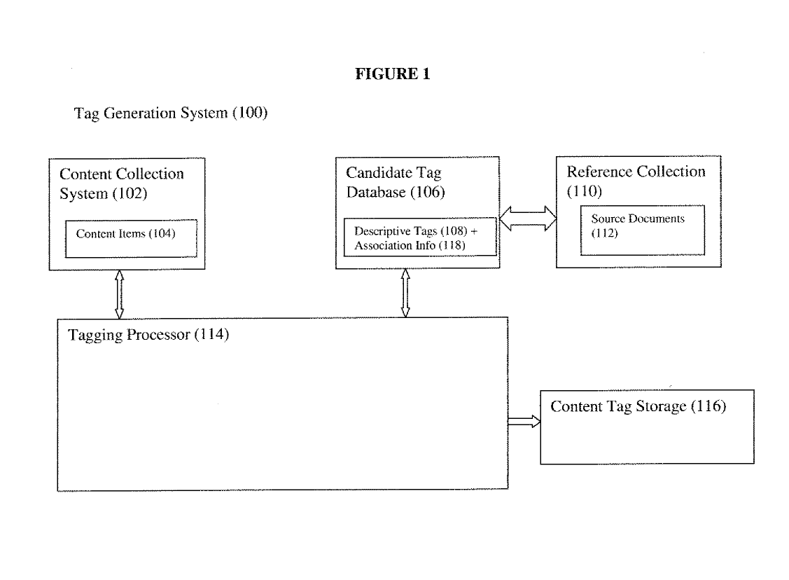

A computer architecture for associating descriptive tags with items of digital content is illustrated in FIG. 1. These embodiments represent a best mode, but other embodiments may fall within the scope of what is intended by this application. It is noted, however, that embodiments may involve a single computer, mobile computer, a networked architecture, a storage architecture, or any other device, or combination of devices capable of transforming, reading and/or storing digital content. The Tag Generation System 100 includes the Content Collection System 102 which stores the Content Items 104. The Content Items 104 may be web pages stored in formats such as HTML, XHTML, or XML, but they may also be documents of other types such as word processing or spreadsheet files, audio files, or pictures, or, in general, any item that is represents information.

For example, the content may be a plurality of posts in threads. Such posts may be organized blog-style, which means in question and answer format as in the formats of blog sites, or alternatively in statement+responses format (e.g. as in sites such as Slashdot). Alternatively, the content may be in the form of news articles or anything else, e.g. video transcripts. Optionally, a user/creator ID may be associated with each content item. This information will aid in the management and tracking of the Content Items 104.

When loading the Content Items 104, they may be accepted as a datafeed from a source to tag (through a tool such as LOGSCANNER™), or by crawling them (through a tool such as PATTERNCRAWLER™). In the embodiment the document(s) to be tagged have a URL, but this may not be the case for all embodiments (e.g. there might be a feed of blog posts where each blog post is separate with an ID, rather than each having its own URL) or an enterprise database organized in a known manner.

The Content Collection System 102 may gather the content for use by the Tagging Processor 114 by retrieving it from storage on a local removable or non-removable storage medium, such as a magnetic disk, an optical disk, or a piece of flash memory, or through some form of network access, such as wireless or wired access to a Local Area Network or through a Wide Area Network such as the Internet.

The Descriptive Tags 108 are short strings of one or more words or other identifiers in length, which potentially reflect some characteristic of the Content Items 104. For example the tags can be words or phrases having semantic meaning, such as “COMPUTERS” or an identifier that can be crossed referenced to a semantic meaning through use of a lookup table, database, or other mechanism. The embodiment may also access a plurality of metatags, such as titles, creation/update timestamps, descriptions, keywords, Dublin Core information, etc. Furthermore, related tags may be added to the identified group of tags based on the metatags. The metatags describe the tags and enhance the subsequent processing of the tags by allowing more informed decisions to be made about how to process the tags.

Tags are associated with the Content Items 104 in a relationship such that a Descriptive Tag 108 is said to describe a given Content Item 104. The value of establishing such a relationship between a Descriptive Tag 108 and a Content Item 104 is based on the larger context of the Content Item 104 and it domina, and how helpful the tag is at helping to summarize and identify the Content Item 104.

For example, using the Descriptive Tag 108 “POLITICAL” for an AP newswire story on Arnold Schwarzenegger's appearance at a San Diego football game would be helpful for a Content Item 104 from NFL.com, where few articles are about politics, but it would probably not be very helpful for a Content Item from politicalbase.com, where most articles are about politics. The reverse would be true for the tag “football” if the contexts were switched.

Note that, in the example described above, the tags may be said to represent topics for the content items. The goal is to choose tags that most aptly represent the content items. The concept of tags as topics is especially apt for blog posts or Slashdot statement+response data, where use of topic tags is helpful for summarizing and encapsulating the data. These topics can later be used to generate pages based on the subject matter of the topics. Of course, tags need not represent topics but can describe the content in various ways.

The Candidate Tag Database 106 may be a relational database, RDF triple store, or similar knowledge storage tool stored, either directly or via network protocols on a removable or non-removable storage medium, such as a magnetic disk, an optical disk, or a piece of flash memory, that stores the Descriptive Tags 108. It also stores the Association Info 118 that describes the relationship of the Descriptive Tags 108 to the Source Documents 112 in the Reference Collection 110. There may optionally be information on collection topic classification in the Reference Collection 110. For example, for ESPN.com™ as a collection, the entire collection might be classified as sports and there might be sub-collections that are football, baseball, etc. Along these lines, collection topic classification may be used to aid in the scoring of at least one tag based on the context of the source document, such as by using the knowledge that a tag is associated with NFL.com™ or politicalbase.com™ as in the example above to help disambiguate the nature of a tag.

Some of the Descriptive Tags 108 may be designated as manual tags. These are the tags that have been personally assigned by users and/or editors. Optionally, the manual tags may be associated for purposes of processing as their reference document the set of all source documents that have been manually tagged.

The Reference Collection 110 is a group of documents, of the same types as previously proposed as for Content Items 104 (i.e., web pages or other documents which may be described by tags). However, the Reference Collection 110 has already been tagged, using known techniques, by the Descriptive Tags 108 in the Candidate Tag Database 106, which effectively allows the Candidate Tag Database 106 to act as a training set for the Association step 204.

The Tagging Processor 114 accesses the plurality of Content Items 104 from the Content Collection System 102, as well as the Descriptive Tags 108 and the Association Info 118 from the Candidate Tag Database 106. It may be any type of computing device which involves a processor, a memory, and is capable of basic input and output. In some cases, the Tagging Processor will also involve connection to the Content Collection System 102 and/or the Candidate Tag Database 106 by a local and/or network connection to facilitate information access by the Tagging Processor 114.

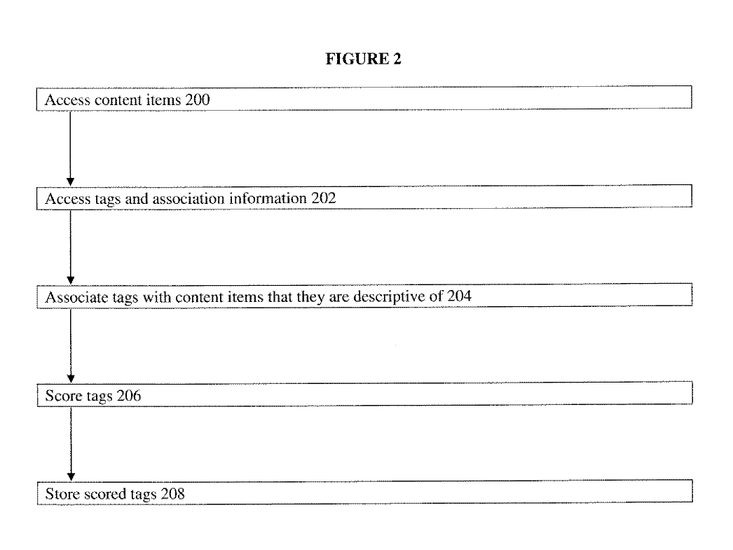

The Tagging Processor interacts with the Content Collection System 102 and the Candidate Tag Database 106 in accordance with the steps of FIG. 2. At the end of its interaction, it places its results in Content Tag Storage 116, which represents a local or network storage device which encodes the results on a removable or non-removable storage medium, such as a magnetic disk, an optical disk, or a piece of flash memory.

Content Tag Storage 116 may store the results in a relational database or an RDF triple store, as noted. By so doing, it transforms the data which the content represents as well as transforming the physical media which store the representation of the data. Here is an example set of fields which it might use to store the results in a relational database which employs SQL:

An example list of fields in a data structure that would be used to store the information in a relational database (such as, for example a SQL database) would be as follows:

Table of Fields Used to Store Tag Association Information

| Field | Type | Description |
|---|---|---|
| URI | Text | URI serving as the Id for the |
| | | document |
| Source | Varchar | The source of the documents being |
| | | analyzed (i.e. the client) |
| Tag | Varchar | Text of the tag |
| Score | Double | Score for the tag |
| Status | Varchar | Status of the tag - enables ability |
| | | for manual override, showing |
| | | previous tags, etc. |
| RefDoc | Text | Identifies reference doc that |
| | | anchors this tag. Need to have a |
| | | type, so might be of the form |
| | | type::id, e.g. Wikipedia:://Frank_zappa |
| ContextWords | Text | Saved lists of context words, |
| | | probably URL encoded of form |
| | | word1=score1&word2=score2&.... |
| CreateTime | | |
| UpdateTime | | |

FIG. 2 illustrates as a flowchart the sequence of steps that are involved in the method of the invention, which the apparatus of FIG. 1 may carry out by executing instructions stored on a computer readable medium. While it is noted that the apparatus of FIG. 1 is only an exemplary design for a machine that will carry out the method of the embodiment, the method of the embodiment can be tied to a computing device with specific and unique characteristics that will become clear from the following description.

The first step in the method is that the computing device which is implementing the method must, in step 200, Access content items. In this step, content items (as discussed in the previous section) must become available to the computing device for processing. There are many ways in which this can occur, including but not limited to reading from a local file, querying from a local database, making a network request for a content file such as a web page, receiving uploaded content, receiving content through a peripheral such as a scanner or a fax or a digital camera, receiving an e-mail message, etc.

Similarly, in step 202, the computing device must access the tags and the association information. While the paradigm for accessing these tags may proceed as in FIG. 1, the access mode for the tags need not be restricted to this embodiment and any form of data interchange, as indicated in the previous paragraph, that makes the tags and the association information available for the computing device will do.

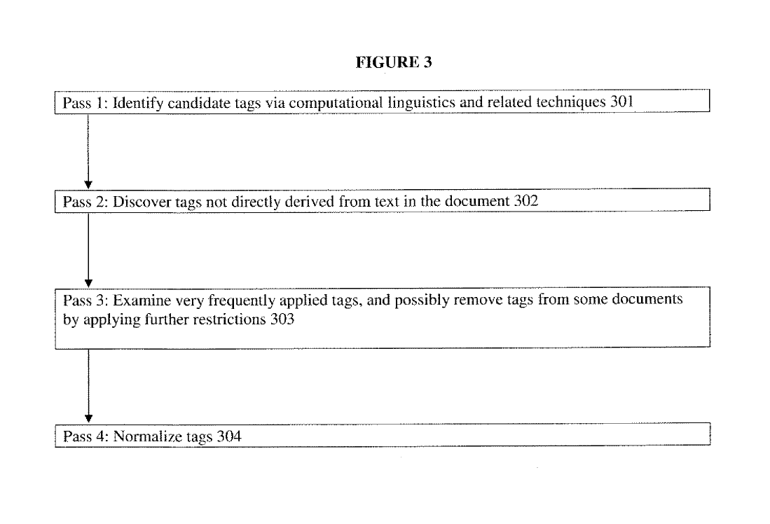

Another step in the method of the invention, of which one embodiment is detailed in FIG. 3, is the step of Associating tags with content items that they are descriptive of 204. This association step is based on utilizing computational linguistics techniques to find relationships between content and tags.

The term “computational linguistics” is used herein to refer to a cross-disciplinary field of modeling of language utilizing computational analysis to process language data. It is primarily derived from the fields of computer science and linguistics. It is also related to the fields of artificial intelligence and cognitive science. Computational linguistics techniques include various algorithms, analytical methods, and procedures from these disciplines which apply structured problem-solving approaches to obtain meaningful results from data. It is well known to use these techniques to use context clues to establish relationships between groups of data. These techniques have not previously been applied to the problems of automatic tag assignment.

Once the association step has been successfully completed, the next step is to score the tags 206. As noted above, the scores form a range, which may be from 0 to 1. Scoring may be done so that a score of 1 reflects a tag where the reference content is identical to the new content and where a score of 0 reflects a tag where the reference content is totally dissimilar to the new content. Scoring can be in any manner or on any scale. For example, scoring can be on a scale of 1 to 5 or by letter grades, A, B, C. Scoring indicates the relevance of the tag with respect to the document.

After the tags are scored, the final step in the method is to store them. Because of the need to associate the tags with their scores, it would be appropriate to use a relational database, an RDF triple store, or similar system. Additional capabilities that would be helpful are a facility for manual validation, import/export, global/local exception lists for export, and the ability to select all tags for a given source, and per URI/source. Additionally, a storage system which is capable of storing temporary sets of tags for a multi-pass system (see the embodiment of FIG. 3) is helpful, which can be accomplished through the use of separated RDF stores or separate databases for temporary tags.

It is noted that the steps of associating 204 (utilizing computational linguistics), scoring 206 and storing 208 may be repeated for each of the plurality of content items or for a subset of the plurality of content items in order to allow flexible processing of the content information. Thus one of the embodiments is: A computer implemented method for associating descriptive tags with content, comprising: accessing a plurality of content items stored in a computer device; accessing a collection of descriptive tags stored in a computer database, the tags being associated with source documents in a reference collection of digital documents stored on a computing device; executing a computational linguistics routine on a computing device to identify at least one tag in the collection that is descriptive of one of the content items; scoring the at least one tag based on the context of the source document associated with the at least one tag in the collection; and storing each of the at least one tags with a score for the content item on a computing device.

These steps may be carried out by an apparatus which may be described by: a content collection unit, from which a plurality of content items can be accessed; a candidate tag database unit, which allows accessing a collection of descriptive tags, the tags being associated with source documents in a reference collection and accessing information on the association that the tags have with a collection of source documents in a reference collection; a tagging processor that utilizes computational linguistics techniques to identify at least one tag in the collection that is descriptive of one of the content items; and scores the at least one tag based on the context of the source document associated with the at least one tag in the collection; and stores each of the at least one tags with a score for the content item.

Alternatively, a set of instructions can be encoded on a computer-readable medium, which when executed by a computer carries out a computer implemented method for associating descriptive tags with content, comprising: accessing a plurality of content items stored in a computer device accessing a collection of descriptive tags stored in a computer database, the tags being associated with source documents in a reference collection of digital documents stored on a computing device, executing a computational linguistics routine on a computing device to identify at least one tag in the collection that is descriptive of one of the content items; scoring the at least one tag based on the context of the source document associated with the at least one tag in the collection, and storing each of the at least one tags with a score for the content item on a computing device.

Also alternatively, there may be a system which carries out the steps of the method, with the characteristics that it is a system for associating descriptive tags with items of digital content, comprising: means for accessing a plurality of content items; means for accessing a collection of descriptive tags, the tags being associated with source documents in a reference collection; means for utilizing computational linguistics techniques to identity at least one tag in the collection that is descriptive of one of the content items; means for scoring the at least one tag based on the context of the source document associated with the at least one tag in the collection, and means for storing each of the at least one tags with a score for the content item.

FIG. 3 illustrates a flowchart of how one embodiment might operate to carry out the processing steps necessary to associate tags with content items. In Pass 1 301, candidate tags are identified via computational linguistics and related techniques. Pass 2 302 discovers tags not directly derived from text in the document. Pass 3 303 examines very frequently applied tags, and possibly removes tags from some documents by applying further restrictions. Pass 4 304 normalizes the tags. The data transformations involved in these passes will now be examined in more detail.

In Pass 1 301 computational linguistics techniques, which may be supplemented and/or replaced by DOM (Document Object Model) technologies, are used to identify candidate tags that may be associated with content items. These computational linguistics techniques include but are not limited to case analysis, formatting (title, bold, heading, etc.), URL linkage, differential frq, collocation, co-occurrence, stemming, synonym, hyponym, hypernym, holonym, meronym, relations, RegEx pattern matches, etc.

Tags should ideally be linked to a reference document or collection. In the embodiment a reference document is used, as specified below, but alternative embodiments may be feasible which store the reference information in other ways. For example, a source may designate Wikipedia™ articles as the reference documents, e.g. if they publish the phrase “vampire slayer” then they want it to be construed as in the corresponding Wikipedia entry for “vampire slayer” and the Wikipedia article will indicate how best to proceed in the tagging process.

Having such an established reference document collection would enable the following process for disambiguation. Take, for example, the tag: “sex change”. First, find that string as a headword in Wikipedia. In general, the embodiment may include source documents in a reference collection on the basis of being a headword or title in the reference collection.

The embodiment would find there not just one but two Wikipedia articles: Gender reassignment and a type of skateboard trick. Using context words from a lexicon based on the reference collection, the embodiment would match to one of the Wikipedia articles that matches best over a threshold of confidence.

Another concept used by the system is that tags are associated with source documents in a reference collection on the basis of being a headword or title in the reference collection. Being a headword or title of an authoritative corpus of reference documents gives a tag good validation as a concept worthy of being a tag.

Tags that are created manually can have the reference document be the set of all source documents that have been manually tagged (i.e. trusting the users or editors who made the manual tags). Manually created tags may be given special weight because they reflect the actual judgment of a human user or editor. On the other hand, this may lead to unreliability, so manual tags need not receive preferential treatment.

It may also be desirable at this stage of the processing to utilize LSA or similar contextual analysis to increase confidence and to suggest further support for the correct sense of a candidate having been found in a content item, e.g. when one finds a sufficient threshold of words in the content item to be strongly represented in the LSA output, where such LSA engine was trained on the corresponding reference document(s) for that candidate tag, then the confidence in the tag being appropriate the content item in question is considerably strengthened.

Yet a further step would be to interconnect with CF, also to increase confidence, which would involve a further strengthening of confidence being obtained when users or editors who tagged many articles with other tags in the content item also tagged it with the one we are suggesting. Note this interconnection means that associations that would be just barely too weak on CF alone and also just barely too weak on our semantic tagging alone, could, when the two are interconnected, come above the confidence threshold. This allows some good tags to emerge that would otherwise be missed.

If the source has its documents organized in a taxonomy, the computation may additionally utilize the taxonomy path (breadcrumb trail) to extract additional tag candidates and to provide context words for disambiguating that tag.

For example, suppose the word “charger” appears in a content item with sparse context, meaning it cannot be disambiguated from the surrounding text alone Further suppose the content item is a user comment posted on a page that falls under the “Power supplies and accessories” category in an electronics ecommerce site. Given that taxonomy information, the system can determine finally that the mention of “charger” is not in the sense of horse, car, or football player, but rather of an electronic device.

Redirects, such as Wikipedia redirects can also be used if they pass a confidence threshold (e.g. fun=>recreation).

The processing may further comprise checking for fuzzy spelling for documents from non-professional sources (e.g. community posts, etc.). This should definitely be triggered by a tag that appears to be a proper name, but does not match a reference document. Matches should be searched for in the set of all tags (i.e. post-process), or other potential tags from the current document (i.e. in the hope for another occurrence with correct spelling). If the document does not overlap enough with the reference document(s), then the tag cannot be used (e.g. there may be a new sense of the word, e.g. a new band called ‘Sex Change’). The last part of this pass is to generate scores for each candidate tag, as noted above.

In Pass 2 302, the objective is to discover tags not directly derived from text in the document. Several baseline methods are employed in this pass. These include only scanning each tag for hypernyms, enforcing minimum tree depth (hypernyms high up in the tree are not useful), looking up context words for the hypernym, and making sure there is some minimum aggregate threshold of them in the source document. Pass 2 302 still requires occurrence of the hypernym in other documents having same candidate tag. Pass 2 302 does not use the tag if the number of documents tagged with the hypernym far exceeds that of the candidate tag (or % of all document). An optional extended method is to create Related Tags, which involves the steps of: For each tag in each source document:
1. Create set of all documents that also contain this tag
2. Distill frequently co-occurring tags
3. See if those tags apply to the post by applying scoring method from 1st pass. It is also possible to incorporate a similarity score between the two documents, or at least to the entire set of their tags.
4. If there is metadata about the type of context word (e.g. “author”), give a bonus to the score. There is a concern about incorrect data getting in on this phase, so it is necessary to be able to set large thresholds for any confidence measures available (but, would be good for related tags).

In Pass 2 302, that were generated (or imported) from first phase are matched. Additionally, we should analyze combinations of tags, by amassing sufficient examples of strongly correlated tags that were generated in the first pass (or generated manually), the system can determine a rule of varying probability that, e.g. if you have <street racing> and you have any of <Toyota>, <Honda>, etc. then [symbol] <Rice Rocket>, or if you have <high horsepower> and any of <Ford>, <GM>, <Chrysler> [symbol] <American Muscle Cars>. Also, it may be appropriate to associate different tags within each category or channel of the reference collection on a single site.

Pass 3 303 is designed to examine very frequently applied tags, and possibly remove tags from some documents by applying further restrictions. These restrictions may include, for blogs, requiring occurrence in question and answer, etc., raising the threshold of score for inclusion (or conversely, applying penalty that might make low scorers fall below threshold). Such a threshold can be used, therefore, to discriminate into included and non-included tags based on a threshold score. However, it may still be a good idea to allow promiscuous tags, since they could indeed be useful (e.g. for a boolean tag search). It may also make sense to place restrictions to a tag globally to a site, since it probably makes sense that a given tag should always resolve to the same sense (i.e. reference document) within a site. If it does not, this might indicate an error, and it may be able to be corrected by switching the sense over for the minority tags.

The number of documents that are tagged with a candidate tag that is removed due to high frequency should be based upon the number of documents in the current corpus being analyzed. It may be necessary to store this count somewhere, since not all documents will generate tags, so just doing distinct(URL) might not be good enough. Also on this pass, the computation can exploit examples of a manually created canonical tagset. This involves generalization from manual tagging. Begin by generalization from multiple users (which requires multiple attestation to use of the tag) to avoid falling prey to one aberrant user tagging 300 books on Amazon “nifty books”.

An example of this technique is when the system notes that “god” when it occurs within the phrase “oh my god” is never manually tagged <God>. In the presence of a sufficiently robust taxonomy, the system notes that most articles falling in a particular node share some particular tags—suggesting that cross-reference tags ought to be generated for all documents sharing those tags, to said node.

Another feature of Pass 3 303 is generating surplus candidates not mentioned verbatim in the text. Collocations, e.g. for <Schroedinger's cat>, if you find the two words “Schroedinger's” and “cat” separated but within n words of each other, it is an indication that <Schroedinger's cat> should be at least a candidate tag for that content item regardless whether it was mentioned verbatim. Other candidates that have both a lot of their context words in the article and all the substantive elements of their lexical gloss in the article (just one of those is not enough).

Another technique is to enter tags into a search engine, find frequently occurring terms across hits in the search engine results page (SERP), and see if they also are in the original article. If they are, make it a candidate.

The objective of Pass 4 304 is normalizing tags. This can include extensional normalizations, for example, if sets of all documents are tagged by “night” and “evening”, then maybe these sets of tags should be merged. The computation has a bias toward the predominant manual tag, if present, e.g. “evening”. Similarly, near-duplicate tags are candidates for merger, e.g. quantum mechanics, quantum theory, quantum physics.

Another way to find candidates for normalization is to look at the lexicon (same synset), and if context words overlap a lot (i.e. low polysemy, etc.). If there is strong indication that normalization is necessary using those 2 methods, then merge tags using the tag most frequently used. Optionally, put this into the output to allow the client site to do minimalist query expansion (or tag matching). Another option is constructing a tag tree, automated with optional manual edit. Since manual tags indicate human judgment, it may be considered desirable to normalize the set of tags with a preference for manual tags.

The source document may be a blog. For each post, it would be helpful to consider any ranking information (e.g. thumbs up/down, was this useful?) that may be provided. The answer should contribute a little less to the score than the questions. It would be helpful to filter out spam, small talk, etc.

Coming up with sense selection for a given tag can be made easier for a given site (e.g. cat=>feline sense on a pets site), by having profiled that site beforehand against a topically classified reference corpus. Mapping of the reference document headword entries (e.g. wikipedia pages) to lexical senseids (for example, lex & designee) helps reference doc lookup (they can select the appropriate article in Wikipedia).

A desirable feature of an embodiment is that it should be able to export results—a list of tags, with scores and a content identifier (URI). Let us examine in more detail the processing that may occur in a four-pass approach to an embodiment. On Pass 1 301, use a corpus scanner to select the set of documents to process. This step is to see if there is a need to determine if we have capability to filter down set to process. There may be a need for additional filters (e.g. URL pattern). The idea behind this step is just to use the import domain (e.g. RSS/finance.yaho.com/ . . . ), but may still be a need for a filter at some point. Probably, there is just a need to allow a regex to match to). Then, for each document, execute potential tag identification, and compute the base score. Next, associate tags to reference documents, and disambiguate (see Reference Document Disambiguation below). After that, refine tag scores. Finally, save tag output for each document to a temporary table (probably with same definition as output table). This table needs to be wiped for given source before starting.

During Pass 2 302 run another same corpus scanner with option to do Pass 2 302 for the tag generation service. During this pass, do cross-pollination of tags from similar looking docs/tags/context words. During Pass 3 303 run through and compute statistics on all the generated tags to selectively cull tags from the tag set. During Pass 4 304 perform the normalization as discussed previously. The output of the tags may go directly into an output table, or into an intermediate file in the database.

When the text for a potential tag leads to a disambiguation problem (e.g. wikipedia disambiguation page, or a multiple designee match), the system needs to select the appropriate reference document that matches the document being analyzed. To do this, a context word-like matching algorithm is used:
1. Collect the potential tags from the source document using basic format, lexical and wiki entry analysis (without disambiguation, obviously). This will be the initial set of document context words.
2. For each tag:
   1. Collect list of context words for each potential reference document that matches the tag text
   2. Compute a match score of the document context words to the context words of each reference document
3. Find the tag with the highest match score, combined with the widest margin to its second place reference document match score, and select the winning reference document for the tag with the highest confidence. Note that in the event of a non-ambiguous match, and a high match score, these would (and should) most likely be selected first. If the highest match score for a tag does not exceed a threshold (i.e. as nearing end of the list of undisambiguated tags), then these tags are force to be discarded (as noted above—could be new usage of the term that is not in wikipedia, etc.)
4. Add in the selected tag's reference document's (from 3.) context words to the main document's context words, with an appropriate penalty based on confidence, etc., as well as DTG (D-Tree Grammars) effect on overlapping context words. Also, it would be possible to take non-overlapping context words from the potential reference documents to the tag that were not selected, and use them as “anti-context words” by adding them to a list in the main document.
5. Go back to step 2., scanning over remaining unvalidated tag=>ref doc entries until there are no more.

For embodiments where an HTML document is involved, it should be possible to implement a method to flag text during the processing that looks like the content in the HTML document. This can be accomplished by implement a few extra features in the part of the embodiment that finds context words. For example, set a flag as to whether to look at various levels of the document such as paragraph level or another level. Optionally, give the user the option to control how much of document to look at. Other options are the ability for title and description to be sent in to the embodiment, in case they were gathered externally. There is a need to treat words in these fields as having some extra weight, as well as compensating if they already verbatim in the article (e.g. some articles on Gamespot.com have the title and description from the RSS feed right at the top of the article).

Ideally, the embodiment will add support for dealing with disambiguation pages, or multiple matches from the Reference (e.g. Wikipedia) page finder—need to be able to get a list of wiki page matches back (i.e. Foo_bar, Foo_bar(Film), Foo_bar(Book), etc.), probably with an associated base match/popularity score.

It will be apparent to those skilled in the art that various modifications and variations can be made in the disclosed embodiments without departing from the scope of the disclosure. Additionally, other embodiments of the apparatus, method, instructions, and system will be apparent to those skilled in the art from consideration of the specification. One of skill in the art will readily be able to program a general purpose computing device to execute instructions to transform the data in accordance with the operations disclosed herein. It is intended that the specification and examples be considered as exemplary only, with a true scope of the disclosure being indicated by the following claims and their equivalents.

### APPENDIX

### Terminology

Tag: a word, short phrase or other indicator which can be applied to a content item (see below) to indicate its meaning, topic or classification.

Source document: any text that is part of a collection of texts. Could include some things not obviously taken to be text, such as the transcript of a video or the table of product feature for each product in an online catalog; herein “article” and “post” are used as types of source documents. Cf. content item.

Content item: any item on a web page or other server that represents information representative of a physical entry, such as a displayed document, a physical image, or the like. Note that source documents may be content items or may be associated with them. A video is a content item and may have an associated source document (the transcript of the video); a still photo is a content that also may have an associated source document (the caption of the photo, or in cases where a photo is a work art, perhaps an extended review of that work of art).

SERP=Search Engine Results Page

CF=collaborative filtering, as standard in the art

LSA=latent semantic analysis, as standard in the art

Gloss=the short definition (usually 100 characters or less) of a word in one particular sense, in a lexical entry for that word

MSI—Master Subject Index, a broad ranging taxonomy of topics, holding in aggregate some millions of documents from the Web, used as a reference corpus in our system

Reference collection or collection of reference documents: a set of documents containing at least one document for each tag to be used in the system where these documents are considered authoritative as to what the tag is about as regards its topic and context.

Reference document: May include items such as maps to an article in wikipedia, maps to a designee, maps to a node in a taxonomy (with appropriate triviality filter) such as the MSI or sites (e.g. buy.com, etc.)

Context words: words that contribute to the relevant context of another word in one of that word's particular senses (if it is a polysemous word), and as such are found more frequently near that word across a general corpus than would be expected by chance. Context words can be used to disambiguate which sense of a word was intended, e.g. “engines” as a context word for “jaguar” raises the probability that “jaguar” is meant to refer to a car rather than a feline.

What is claimed:

1. A computer implemented method for associating descriptive tags with content, comprising:
accessing a plurality of content items stored in a computer device;
accessing a collection of descriptive tags stored in a computer database, the tags being associated with source documents in a reference collection of digital documents stored on a computing device;
executing a computational linguistics routine on a computing device to identify at least one tag in the collection that is descriptive of one of the content items;
scoring the at least one tag based on the context of the source document associated with the at least one tag in the collection; and
storing each of the at least one tags with a score for the content item on a computing device.

2. The method of claim 1, further comprising repeating said utilizing, scoring, and storing steps for each of the plurality of content items.

3. The method of claim 1, wherein part of the source documents tags in said collection have been assigned tags manually.

4. The method of claim 3, wherein tags that are created manually are associated with, as their reference document, the set of all source documents that have been manually tagged.

5. The method of claim 3, wherein sets of tags are normalized with a preference for manual tags.

6. The method of claim 1, further comprising repeating said utilizing, scoring, and storing steps for a subset of the plurality of content items.

7. The method of claim 1, wherein the plurality of content items consist of a plurality of posts in threads.

8. The method of claim 7, wherein the posts in threads are organized in question-and-answer format.

9. The method of claim 1, wherein each content item has a user/creator id.

10. The method of claim 1, wherein collection topic classification is used to aid in the scoring of the least one tag based on the context of the source document.

11. The method of claim 1, wherein the method accesses a plurality of metatags.

12. The method in claim 11, where related tags are added to the identified group of tags based on the metatags.

13. The method of claim 1, wherein the score is between 0 and 1.

14. The method of claim 1, wherein the computational linguistics techniques include one or more of: case analysis, formatting analysis, URL linkage, differential frq, collocation, co-occurrence, stemming, synonym, hyponym, hypernym, holonym, meronym, relations, RegEx pattern matches.

15. The method of claim 1, wherein tags are associated with source documents in a reference collection on the basis of being a headword or title in said reference collection.

16. The method of claim 1, wherein the confidence of said computational linguistics is strengthened using LSA techniques.

17. The method of claim 1, wherein the confidence of said computational linguistics is strengthened using CF techniques.

18. The method of claim 1, where, if the source has its documents organized in a taxonomy, the taxonomy path is used to extract additional tag candidates and to provide context words for disambiguating the tag.

19. The method in claim 1, where the source documents in a reference collection are one or more of: maps to an article in Wikipedia, maps to a designee, maps to a node in a taxonomy, MSI, or websites.

20. The method in claim 1, where the tag identification can check for fuzzy spelling matches.

21. The method in claim 1, wherein a second attempt is made to identify tags by scanning each of the previously derived tags for hypernyms.

22. The method in claim 21, where hypernyms are only retained at an enforced minimum tree depth.

23. The method in claim 1, further comprising the step of requiring occurrence in question and answer.

24. The method in claim 1, further comprising the step of discriminating into included and non-included tags based on a threshold score.

25. The method in claim 24, further comprising the step of raising the threshold for inclusion

26. The method in claim 24, further comprising the step of applying a penalty for low scores.

27. The method in claim 1, further comprising the step of applying global restrictions based on the reference collection.

28. The method in claim 1, further comprising identifying tags that are collocations as candidate tags.

29. The method in claim 1, wherein the source document is a blog.

30. The method in claim 29, wherein the scoring step considers any ranking information in the blog.

31. The method in claim 29, wherein the performance of the scoring step is improved by the use of a topically classified reference corpus.

32. The method in claim 1, wherein DOM supplements and/or replaces computational linguistics techniques to carry out the identifying step.

33. The method in claim 1, wherein the scored tags are used to represent topics.

34. The method in claim 33, wherein the scored tags are used to facilitate organizing the content based on the topics.

35. The method in claim 33, wherein the topic tags are used to facilitate searching the content based on the topics.

36. The method in claim 33, wherein topic tags are used to compile a page of the content tagged by a topic.

37. An apparatus for associating descriptive tags with items of digital content, said apparatus comprising:
a content collection unit, from which a plurality of content items can be accessed;
a candidate tag database unit, which allows accessing a collection of descriptive tags, the tags being associated with source documents in a reference collection and accessing information on the association that the tags have with a collection of source documents in a reference collection;
a tagging processor that utilizes computational linguistics techniques to identify at least one tag in the collection that is descriptive of one of the content items; and
scores the at least one tag based on the context of the source document associated with the at least one tag in the collection; and
stores in a content tag storage unit each of the at least one tags with a score for the content item.

38. The apparatus of claim 37, wherein the tagging processor repeats said utilizing, scoring, and storing steps for each of the plurality of content items.

39. The apparatus of claim 37, wherein part of the source documents tags in said collection have been assigned tags manually.

40. The apparatus of claim 39, wherein tags that are created manually are associated with, as their reference document, the set of all source documents that have been manually tagged.

41. The apparatus of claim 39, wherein sets of tags are normalized with a preference for manual tags.

42. The apparatus of claim 37, wherein the tagging processor repeats said utilizing, scoring, and storing steps for a subset of the plurality of content items.

43. The apparatus of claim 37, wherein the plurality of content items consist of a plurality of posts in threads.

44. The apparatus of claim 43, wherein the posts in threads are organized in question-and-answer format.

45. The apparatus of claim 37, wherein each content item has a user/creator id.

46. The apparatus of claim 37, wherein collection topic classification is used to aid in the scoring of the least one tag based on the context of the source document.

47. The apparatus of claim 37, wherein the method accesses a plurality of metatags.

48. The apparatus in claim 47, where related tags are added to the identified group of tags based on the metatags.

49. The apparatus of claim 37, wherein the score is between 0 and 1.

50. The apparatus of claim 37, wherein the computational linguistics techniques include one or more of: case analysis, formatting analysis, URL linkage, differential frq, collocation, co-occurrence, stemming, synonym, hyponym, hypernym, holonym, meronym, relations, RegEx pattern matches.

51. The apparatus of claim 37, wherein tags are associated with source documents in a reference collection on the basis of being a headword or title in said reference collection.

52. The apparatus of claim 37, wherein the confidence of said computational linguistics is strengthened using LSA techniques.

53. The apparatus of claim 37, wherein the confidence of said computational linguistics is strengthened using CF techniques.

54. The apparatus of claim 37, where, if the source has its documents organized in a taxonomy, the taxonomy path is used to extract additional tag candidates and to provide context words for disambiguating the tag.

55. The apparatus of claim 37, where the source documents in a reference collection are one or more of: maps to an article in Wikipedia, maps to a designee, maps to a node in a taxonomy, MSI, or websites.

56. The apparatus of claim 37, where the tag identification can check for fuzzy spelling matches.

57. The apparatus of claim 37, wherein a second attempt is made to identify tags by scanning each of the previously derived tags for hypernyms.

58. The apparatus of claim 57, where hypernyms are only retained at an enforced minimum tree depth.

59. The apparatus of claim 37, further comprising the step of requiring occurrence in question and answer.

60. The apparatus of claim 37, where the tagging processor further discriminates the tags into included and non-included tags based on a threshold score.

61. The apparatus of claim 60, where the tagging processor further takes the step of raising the threshold for inclusion.

62. The apparatus of claim 60, where the tagging processor further takes the step of applying a penalty for low scores.

63. The apparatus of claim 37, where the tagging processor further takes the step of applying global restrictions based on the reference collection.

64. The apparatus of claim 37, further comprising identifying tags that are collocations as candidate tags.

65. The apparatus of claim 37, wherein the source document is a blog.

66. The apparatus of claim 65, wherein the scoring by the tagging processor considers any ranking information in the blog.

67. The apparatus of claim 65, wherein the performance of the scoring by the tagging processor is improved by the use of a topically classified reference corpus.

68. The apparatus of claim 37, wherein DOM supplements and/or replaces computational linguistics techniques to carry out the identifying by the tagging processor.

69. The apparatus of claim 37, wherein the scored tags are used to represent topics.

70. The apparatus of claim 69, wherein the scored tags are used to facilitate organizing the content based on the topics.

71. The apparatus of claim 69, wherein the topic tags are used to facilitate searching the content based on the topics.

72. The method in claim 69, wherein topic tags are used to compile a page of the content tagged by a topic.

73. A set of instructions encoded on encoded on a computer-readable medium, which when executed by a computer carries out a computer implemented method for associating descriptive tags with content, comprising:
accessing a plurality of content items stored in a computer device;
accessing a collection of descriptive tags stored in a computer database, the tags being associated with source documents in a reference collection of digital documents stored on a computing device;
executing a computational linguistics routine on a computing device to identify at least one tag in the collection that is descriptive of one of the content items;
scoring the at least one tag based on the context of the source document associated with the at least one tag in the collection; and
storing each of the at least one tags with a score for the content item on a computing device.

74. The method of claim 73, further comprising repeating said utilizing, scoring, and storing steps for each of the plurality of content items.

75. The set of instructions of claim 73, wherein part of the source documents tags in said collection have been assigned tags manually.

76. The set of instructions of claim 75, wherein tags that are created manually are associated with, as their reference document, the set of all source documents that have been manually tagged.

77. The set of instructions of claim 75, wherein sets of tags are normalized with a preference for manual tags.

78. The set of instructions of claim 73, further comprising repeating said utilizing, scoring, and storing steps for a subset of the plurality of content items.

79. The set of instructions of claim 73, wherein the plurality of content items consist of a plurality of posts in threads.

80. The set of instructions of claim 79, wherein the posts in threads are organized in question-and-answer format.

81. The set of instructions of claim 73, wherein each content item has a user/creator id.

82. The set of instructions of claim 73, wherein collection topic classification is used to aid in the scoring of the least one tag based on the context of the source document.

83. The set of instructions of claim 73, wherein the method accesses a plurality of metatags.

84. The set of instructions in claim 83, where related tags are added to the identified group of tags based on the metatags.

85. The set of instructions of claim 73, wherein the score is between 0 and 1.

86. The set of instructions of claim 73, wherein the computational linguistics techniques include one or more of: case analysis, formatting analysis, URL linkage, differential frq, collocation, co-occurrence, stemming, synonym, hyponym, hypernym, holonym, meronym, relations, RegEx pattern matches.

87. The set of instructions of claim 73, wherein tags are associated with source documents in a reference collection on the basis of being a headword or title in said reference collection.

88. The set of instructions of claim 73, wherein the confidence of said computational linguistics is strengthened using LSA techniques.

89. The set of instructions of claim 73, wherein the confidence of said computational linguistics is strengthened using CF techniques.

90. The set of instructions of claim 73, where, if the source has its documents organized in a taxonomy, the taxonomy path is used to extract additional tag candidates and to provide context words for disambiguating the tag.

91. The set of instructions of claim 73, where the source documents in a reference collection are one or more of: maps to an article in Wikipedia, maps to a designee, maps to a node in a taxonomy, MSI, or websites.

92. The set of instructions of claim 73, where the tag identification can check for fuzzy spelling matches.

93. The set of instructions of claim 73, wherein a second attempt is made to identify tags by scanning each of the previously derived tags for hypernyms.

94. The set of instructions of claim 93, where hypernyms are only retained at an enforced minimum tree depth.

95. The set of instructions of claim 73, further comprising the step of requiring occurrence in question and answer.

96. The set of instructions of claim 73, further comprising the step of discriminating into included and non-included tags based on a threshold score.

97. The set of instructions of claim 96, further comprising the step of raising the threshold for inclusion.

98. The set of instructions of claim 96, further comprising the step of applying a penalty for low scores.

99. The set of instructions of claim 73, further comprising the step of applying global restrictions based on the reference collection.

100. The set of instructions of claim 73, further comprising identifying tags that are collocations as candidate tags.

101. The set of instructions of claim 73, wherein the source document is a blog.

102. The set of instructions of claim 101, wherein the scoring step considers any ranking information in the blog.

103. The set of instructions of claim 101, wherein the performance of the scoring step is improved by the use of a topically classified reference corpus.

104. The set of instructions of claim 73, wherein DOM supplements and/or replaces computational linguistics techniques to carry out the identifying step.

105. The method in claim 73, wherein the scored tags are used to represent topics.

106. The method in claim 105, wherein the scored tags are used to facilitate organizing the content based on the topics.

107. The method in claim 105, wherein the topic tags are used to facilitate searching the content based on the topics.

108. The method in claim 105, wherein topic tags are used to compile a page of the content tagged by a topic.

109. A system for associating descriptive tags with items of digital content, comprising:
means for accessing a plurality of content items;
means for accessing a collection of descriptive tags, the tags being associated with source documents in a reference collection;
means for utilizing computational linguistics techniques to identify at least one tag in the collection that is descriptive of one of the content items;
means for scoring the at least one tag based on the context of the source document associated with the at least one tag in the collection; and
means for storing each of the at least one tags with a score for the content item.

110. The system of claim 109, where said system further repeats said utilizing, scoring, and storing steps for each of the plurality of content items.

111. The system of claim 109, wherein part of the source documents tags in said collection have been assigned tags manually.

112. The system of claim 111, wherein tags that are created manually are associated with, as their reference document, the set of all source documents that have been manually tagged.

113. The system of claim 111, wherein sets of tags are normalized with a preference for manual tags.

114. The system of claim 109, where said system further repeats said utilizing, scoring, and storing steps for a subset of the plurality of content items.

115. The system of claim 109, wherein the plurality of content items consist of a plurality of posts in threads.

116. The system of claim 115, wherein the posts in threads are organized in question-and-answer format.

117. The system of claim 109, wherein each content item has a user/creator id.

118. The system of claim 109, wherein collection topic classification is used to aid in the scoring of the least one tag based on the context of the source document.

119. The system of claim 109, wherein the system accesses a plurality of metatags.

120. The system of claim 119, wherein the system adds related tags to the identified group of tags based on the metatags.

121. The system of claim 109, wherein the score is between 0 and 1.

122. The system of claim 109, wherein the computational linguistics techniques include one or more of: case analysis, formatting analysis, URL linkage, differential frq, collocation, co-occurrence, stemming, synonym, hyponym, hypernym, holonym, meronym, relations, RegEx pattern matches.

123. The system of claim 109, wherein tags are associated with source documents in a reference collection on the basis of being a headword or title in said reference collection.

124. The system of claim 109, wherein the confidence of said computational linguistics is strengthened using LSA techniques.

125. The system of claim 109, wherein the confidence of said computational linguistics is strengthened using CF techniques.

126. The system of claim 109, where, if the source has its documents organized in a taxonomy, the taxonomy path is used to extract additional tag candidates and to provide context words for disambiguating the tag.

127. The system in claim 109, where the source documents in a reference collection are one or more of: maps to an article in Wikipedia, maps to a designee, maps to a node in a taxonomy, MSI, or websites.

128. The system in claim 109, where the tag identification can check for fuzzy spelling matches.

129. The system in claim 109, wherein a second attempt is made to identify tags by scanning each of the previously derived tags for hypernyms.

130. The system in claim 129, where hypernyms are only retained at an enforced minimum tree depth.

131. The system in claim 109, where the system has further means for requiring occurrence in question and answer.

132. The system in claim 109, where the system has further means for discriminating into included and non-included tags based on a threshold score.

133. The system in claim 132, where the system has further means for raising the threshold for inclusion.

134. The system in claim 132, where the system has further means for applying a penalty for low scores.

135. The system in claim 109, where the system has further means for applying global restrictions based on the reference collection.

136. The system in claim 109, where the system has further means for identifying tags that are collocations as candidate tags.

137. The system in claim 109, wherein the source document is a blog.

138. The system in claim 137, wherein the scoring step considers any ranking information in the blog.

139. The system in claim 137, wherein the performance of the scoring step is improved by the use of a topically classified reference corpus.

140. The system in claim 109, wherein DOM supplements and/or replaces computational linguistics techniques in the operation of said means for utilizing computational linguistics.

141. The method in claim 109, wherein the scored tags are used to represent topics.

142. The method in claim 141, wherein the scored tags are used to facilitate organizing the content based on the topics.

143. The method in claim 141, wherein the topic tags are used to facilitate searching the content based on the topics.

144. The method in claim 141, wherein topic tags are used to compile a page of the content tagged by a topic.
